(19) United States
(12) Patent Application Publication
(10) Pub. No.: US 2024/0319398 A1
(43) Pub. Date: Sep. 26, 2024

(54) POLE MOUNTED LOCATOR

(71) Applicant: The Charles Machine Works, Inc., Perry, OK (US)

(72) Inventor: Jeffrey Wayne Hollas, Edmond, OK (US)

(21) Appl. No.: 18/597,053

(22) Filed: Mar. 6, 2024

Related U.S. Application Data
(60) Provisional application No. 63/453,298, filed on Mar. 20, 2023.

(51) Int. Cl. G01V 3/08; G01S 19/14

(52) U.S. Cl. CPC G01V 3/081; G01S 19/14

(57) ABSTRACT

A mapping device for use in locating and mapping underground utility lines. The mapping device includes a survey pole interposed between an electromagnetic locator and a satellite navigation receiver such that a longitudinal axis extends through the center of each of the components. During operation, because the locator and the satellite navigation receiver are aligned, the locator may locate an underground utility line and the satellite navigation receiver may pinpoint the location of the underground utility at the same time using a single step process. Data acquired by the locator and the satellite navigation receiver may be displayed on a map on a display device during operation.

### RELATED APPLICATIONS

This application claims the benefit of U.S. provisional patent application Ser. No. 63/453,298, authored by Hollas, and filed on Mar. 20, 2023, the entire contents of which are incorporated herein by reference.

### BACKGROUND

Before commencing any underground construction operations, it is necessary to identify and locate any utility lines existing below ground. Once identified, these utility lines can be accurately mapped by pinpointing their GPS or GNSS coordinates. One known method of mapping the underground environment involves a two-step process: first, locating the utility line using an electromagnetic locator, and then precisely pinpointing its location using a survey pole equipped with a satellite navigation receiver. Such method can be cumbersome because it necessitates the use of two hands, one for holding the survey pole and another for the locator device. The same method is also used to map any other locatable underground obstructions.

Another known method for locating and mapping underground utility lines is to attach the locator to the side of the survey pole, thereby freeing one of the operator's hands. However, when the locator is attached to the side of the survey pole, it becomes positioned offset from the satellite navigation receiver. As a result, the satellite navigation receiver is pinpointing a different location from that identified by the locator. Secondary calculations are thus required to account for the offset position of the locator.

Another known method involves directly supporting the satellite navigation receiver on the locator and not using a survey pole, as shown for example in U.S. Pat. No. 11,474,262, issued to Regini et al., and U.S. Pat. No. 9,465,129, issued to Olsson et al. However, in these known embodiments, the satellite navigation receiver is mounted on the side of the locator. Consequently, a two-step process is required to identify and map the utility line. Initially, the locator locates the underground line. Then, the locator is repositioned or tilted to allow the satellite navigation receiver to pinpoint the GPS or GNSS location of the utility line at the same location identified by the locator. Mounting the satellite navigation receiver directly on the locator also diminishes its accuracy due to its proximity to the ground surface.

The above-described mapping devices require two hands, a two-step process, and/or secondary calculations to locate and map underground utility lines or obstructions. There is a need in the art for a mapping device that can simultaneously locate and map underground utility lines using a single step and without the need for any secondary calculations. There is also a need in the art for a way to easily view the identified and pinpointed locations on a map in real-time during the mapping operation.

### SUMMARY

The present application discloses an underground mapping device comprising a survey pole having a first longitudinal axis, and a satellite navigation receiver supported on the survey pole. The mapping device further comprises a locator supported on the survey pole. The locator has a second longitudinal axis and comprises at least one antenna configured to detect an electromagnetic field. Further, the first longitudinal axis of the survey pole coincides with the second longitudinal axis of the locator.

The present application also discloses an underground mapping device comprising a survey pole having an elongate body with opposed upper and lower ends. The mapping device further comprises a satellite navigation receiver supported on the upper end of the survey pole, and a locator supported on the lower end of the survey pole. The locator comprises at least one antenna configured to detect an electromagnetic field. Further, at least a portion of the locator is positioned within a footprint of the satellite navigation receiver.

The mapping devices disclosed herein may also each comprise a display device in communication with the satellite navigation receiver and the locator. The display device is configured to display locating data received from the locator and a map of points identified by the satellite navigation receiver.

### BRIEF DESCRIPTION OF THE DRAWINGS

FIG. 1 is an illustration of a mapping operation for locating and mapping underground utility lines utilizing a mapping device disclosed herein.

FIG. 2 is a side elevational view of the mapping device shown in FIG. 1. A display device used with the mapping device is shown in a horizontal orientation.

FIG. 3 is a rear elevational view of the mapping device shown in FIG. 2.

FIG. 4 is a side elevational and exploded view of the mapping device shown in FIG. 2.

FIG. 5 is a front elevational view of the display device shown in FIG. 2, but the display device is rotated to a vertical orientation.

FIG. 6 is a front elevational view of the locator used with the mapping device shown in FIG. 2.

FIG. 7 is a front elevation and sectional view of the locator shown in FIG. 6.

FIG. 8 is a top perspective view of another embodiment of a mapping device disclosed herein.

### DETAILED DESCRIPTION

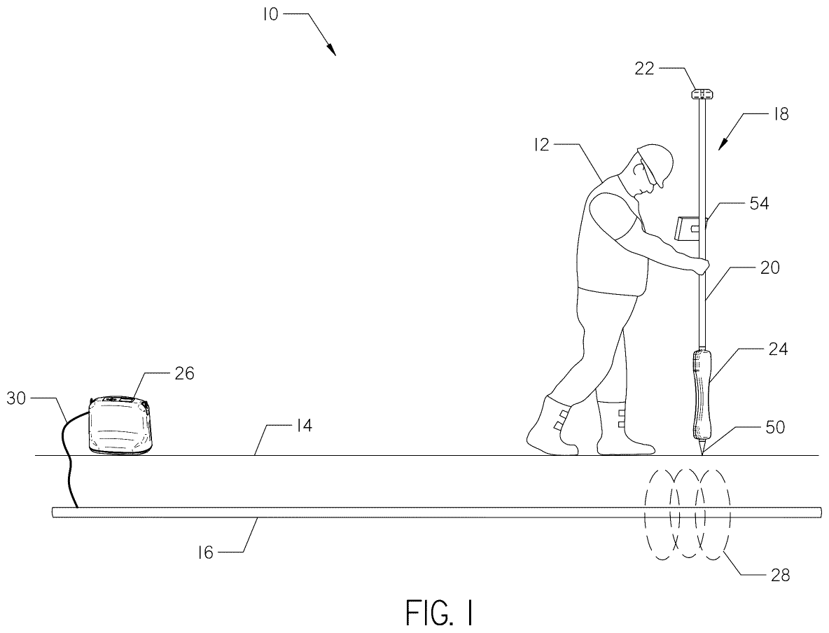

Turning now to the figures, FIG. 1 shows a mapping operation 10. An operator 12 is standing on a ground surface 14 over a buried utility line 16 and is shown holding one embodiment of a mapping device 18 disclosed herein. The mapping device 18 comprises an elongate survey pole 20, a satellite navigation receiver 22, and an electromagnetic locator 24 assembled as a single hand-held device. In contrast to mapping devices known in the art, the locator 24 is positioned directly in-line with the survey pole 20 and the satellite navigation receiver 22. At least a portion of the locator 24 is positioned within a footprint of the satellite navigation receiver 22. As a result, the locations pinpointed by the satellite navigation receiver 22 directly correspond to underground locations detected by the locator 24. Such measurements can be taken simultaneously using a one-step process. There is no need for any secondary calculations or measurements. Thus, a point along the underground utility line 16 can be located and mapped using a single step and a single hand.

Continuing with FIG. 1, to actively locate the buried utility line 16, a transmitter 26 is traditionally used to induce an electromagnetic current or signal into the utility line 16. The signal induced into the line 16 radiates from the line 16 throughout its length. Electromagnetic signals 28 radiating from the utility line 16 are detected by the locator 24, thereby identifying the location of the buried line 16.

The transmitter 26 is shown situated on the ground surface 14 and connected to the utility line 16 using a wire 30 in FIG. 1. While not shown, the wire 30 may be directly coupled to a wire included in the buried line 16 or may be coupled to a clamp placed around the circumference of the line 16 and configured to induce a current into the line 16. Alternatively, certain utility lines, such as electrical cables, may naturally emit an electromagnetic field that the locator 24 can passively detect. A system and method for inducing a current on a buried utility line is described in more detail in U.S. Pat. No. 5,264,795, issued to Rider, the entire contents of which are incorporated herein by reference.

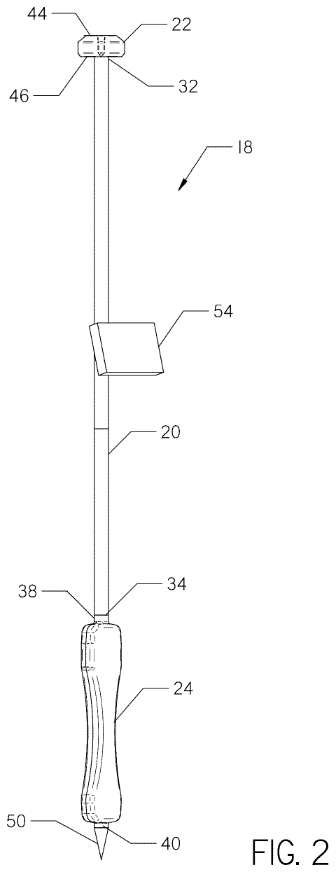

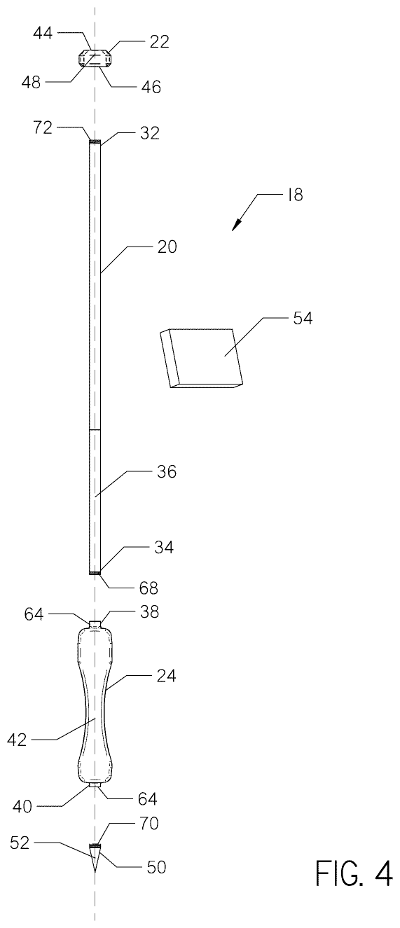

Turning to FIGS. 2-4, the survey pole 20 of the mapping device 18 comprises opposed upper and lower ends 32 and 34 and has a central first longitudinal axis 36 extending through its ends 32 and 34, as shown in FIG. 4. The survey pole 20 may be of varying types and lengths known in the art. Preferably, the pole 20 is an extension pole of less than two meters in length.

The electromagnetic locator 24 is attached to the lower end 34 of the survey pole 20. The locator 24 comprises opposed upper and lower ends 38 and 40 and has a central second longitudinal axis 42 extending through its ends 38 and 40, as shown in FIG. 4. When the locator 24 is attached to the lower end 34 of the survey pole 20, the first longitudinal axis 36 coincides with the second longitudinal axis 42.

The satellite navigation receiver 22 is supported on the upper end 32 of the survey pole 20 and comprises any type of satellite navigation receiver known in the art, such as a GPS or GNSS receiver. Additionally, the satellite navigation receiver 22 may be configured to perform real-time kinematic (RTK) positioning to improve its accuracy. The satellite navigation receiver 22 comprises opposed upper and lower ends 44 and 46 and has a central third longitudinal axis 48 extending through its opposed ends 44 and 46, as shown in FIG. 4. When the satellite navigation receiver 22 is attached to the upper end 32 of the survey pole 20, the third longitudinal axis 48 coincides with the first and second longitudinal axes 36 and 42. Therefore, in contrast to mapping devices known in the art, the locator 24 and the satellite navigation receiver 22 are not offset from one another.

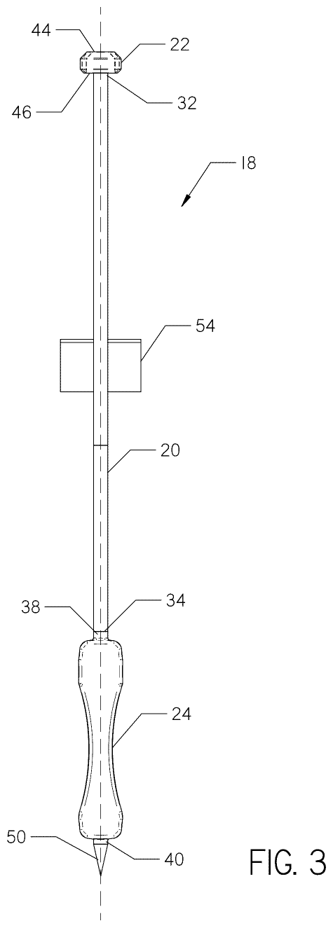

Continuing with FIGS. 2-4, the mapping device 18 further comprises a spike 50 attached to the lower end 40 of the locator 24. The locator 24 is thus interposed directly between the pole 20 and the spike 50. A fourth longitudinal axis 52 extends through the center of the spike 50 and coincides with the first, second, and third longitudinal axes 36, 42, and 48, as shown in FIG. 4. Because all of the longitudinal axes 36, 42, 48, and 52 coincide within one another, a single longitudinal axis 53 extends through the center of each of the satellite navigation receiver 22, the survey pole 20, the locator 24, and the spike 50, as shown in FIG. 3.

The spike 50 may be made of a non-ferrous material, such as bronze, to reduce interference with the electromagnetic signals. Other accessories may be used in place of or in conjunction with the spike 50. For example, a wheel or tripod may be used with the mapping device 18. If another device is used in place of the spike 50, such device is positioned on the lower end 40 of the locator 24 such that its longitudinal axis coincides with the longitudinal axis 42 of the locator 24.

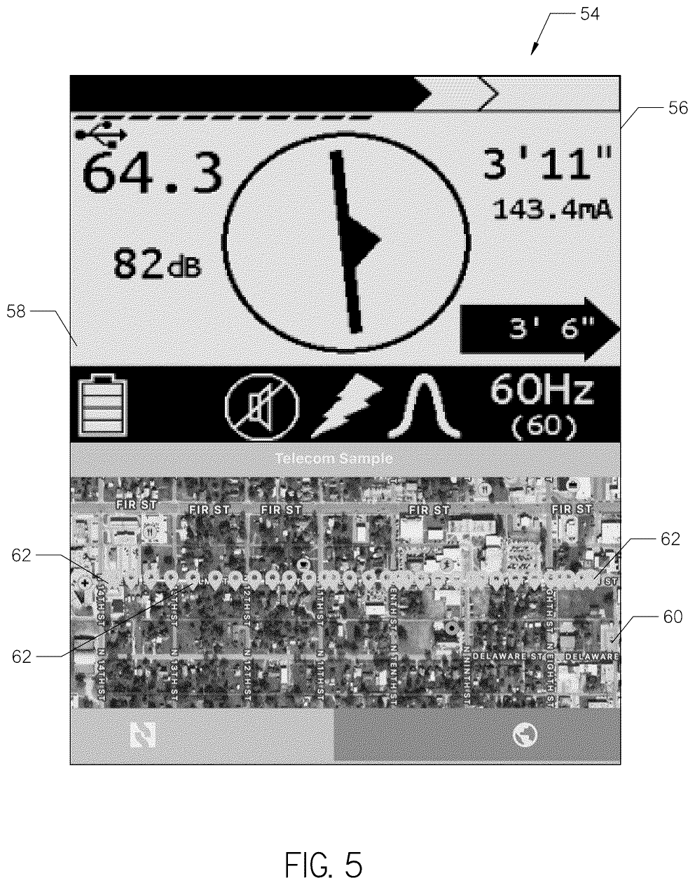

Staying with FIGS. 1-4, the mapping device 18 further comprises a hand-held display device 54, such as a phone, tablet, or computer. The display device 54 may be supported directly on the survey pole 20 and may be detached from the pole 20, as needed. When supported on the survey pole 20, the display device 54 may be rotatable between a horizontal orientation, as shown in FIGS. 1-4, and a vertical orientation, as shown in FIG. 5. Both the satellite navigation receiver 22 and the locator 24 are in communication with the display device 54. The components may communicate wirelessly, for example over Bluetooth, or communicate using wired or cable connections. One or more of the components of the mapping device 18 may be configured to operate using the same battery. In such case, all of the components using the same battery may be simultaneously charged using a single cord. In alternative embodiments, the components may utilize separate batteries and be charged independently.

Turning to FIG. 5, the display device 54 comprises a display screen 56. The display screen 56 is configured to receive and display data received from the locator 24, as shown by a locator data screen 58 in FIG. 5. The locator data screen 58 is further configured with controls that allow an operator to manipulate the locator 24. For example, the display device 54 is configured to have bidirectional communication with the locator 24 to change settings such as gain, frequency, antenna mode, etc.

The display device 54 is further configured to receive and display data received from the satellite navigation receiver 22, as shown by a map screen 60 in FIG. 5. Mapping software configured for use with ArcGIS plug-ins, or the like is downloaded onto the display device 54. For example, the software may be in the form of a downloadable application. The software is configured to use data received from the satellite navigation receiver 22 and display the locations pinpointed by the receiver 22 on a geographical map. For example, a plurality of locations 62 are shown on an aerial map in FIG. 5. The software may also utilize data from the locator 24 to further identify each location on the map. The display device 54 may further be configured to display the locator data screen 58 and the map screen 60 side-by-side on a split screen, as shown in FIG. 5.

During operation, the mapping device 18 may be calibrated with the mapping software by programing the height of the satellite navigation receiver 22 into the software using the display device 54. Information received from the locator 24 and the satellite navigation receiver 22 is displayed in real-time on the locator data screen 58 and the map screen 60 for viewing by an operator. Thus, an operator may easily observe and track the location of underground utility lines or obstructions as the operator utilizes the mapping device 18.

In alternative embodiments, the display device 54 may just display data received from the locator 24 and/or the satellite navigation receiver 22 without the use of mapping software. The display device 54 shown in FIG. 5 comprises a touch screen interface. In alternative embodiments, the display device 54 may include raised buttons in addition to the touch screen or may not include a touch screen and only utilize raised buttons or other controls.

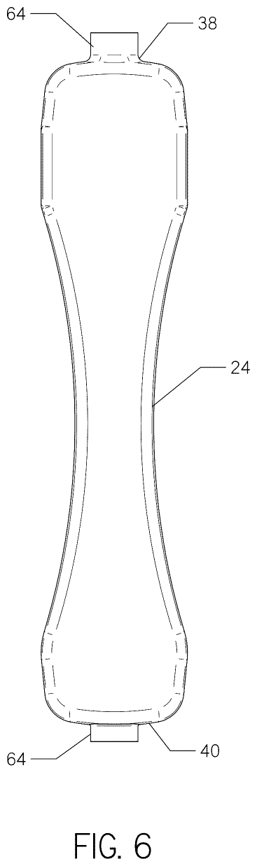

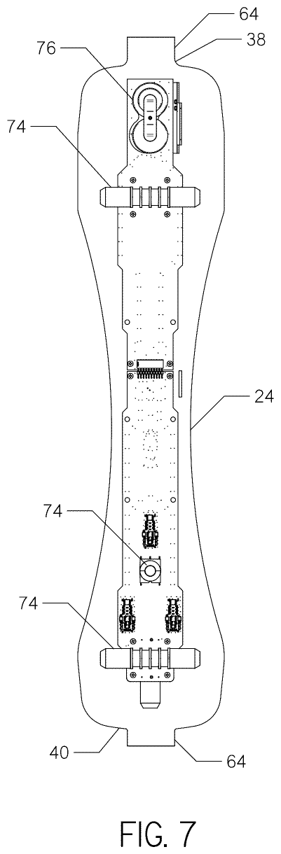

Turning to FIGS. 6 and 7, one embodiment of the locator 24 is shown in more detail. As described above, the locator 24 is configured to actively or passively detect electromagnetic fields or signals evidencing the presence of buried utility lines or other obstructions. The upper and lower ends 38 and 40 of the locator 24 each comprise an attachment feature 64. Likewise, the lower end 34 of the survey pole 20 and an upper end of the spike 50 comprise corresponding attachment features 68 and 70, as shown in FIG. 4. The attachment features 64, 68, and 70 shown in FIGS. 4, 6, and 7 each comprise threads configured to mate with one another. In alternative embodiments, the attachment features 64, 68, and 70 may be configured to secure to one another using other means known in the art, such as interference fit or fasteners.

Continuing with FIG. 4, the upper end 32 of the survey pole 20 likewise comprises an attachment feature 72 for mating with a corresponding attachment feature (not shown) on the lower end 46 of the satellite navigation receiver 22. Such features may utilize threads or other forms of securing the devices together known in the art.

Turning back to FIG. 7, the locator 24 comprises at least one antenna 74 configured to detect an electromagnetic field. The locator 24 shown in FIG. 7 comprises three orthogonally situated antennas 74. Each antenna 74 detects a magnetic field on a different axis. Electromagnetic signals detected by the antennas 74 are amplified and filtered before being transmitted to the display device 54. A processor included in the display device 54 processes the signals received from the locator 24 and displays the signals in a readable form for the operator. The locator 24 is powered by a battery 76, shown in FIG. 7. One embodiment of a locator is described in more detail in U.S. Pat. No. 10,042,074, issued to Bailey, the entire contents of which are incorporated herein by reference.

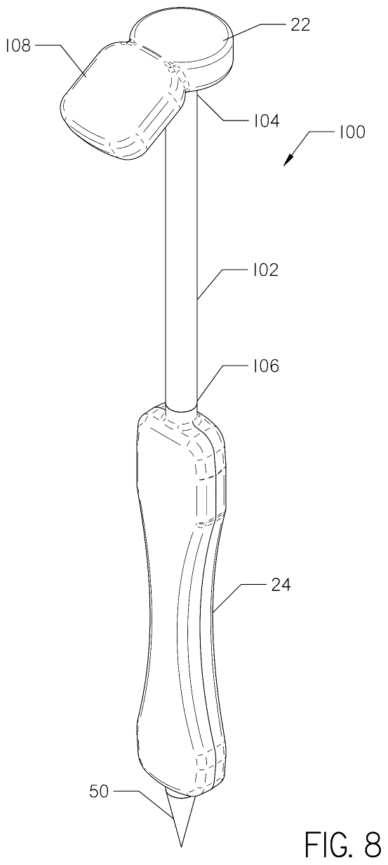

Turning to FIG. 8, an alternative embodiment of a mapping device 100 disclosed herein is shown. The mapping device 100 is like the mapping device 18 shown in FIGS. 1-4, but the mapping device 100 utilities a shorter survey pole 102. Like the mapping device 18, the mapping device 100 comprises the locator 24 and the satellite navigation receiver 22. The locator 24 and the satellite navigation receiver 22 are supported on upper and lower ends 104 and 106 of the pole 102 such that the components have coincident longitudinal axes like that of the mapping device 18. Likewise, the spike 50 is attached to the lower end 40 of the locator 24.

In contrast to the mapping device 18, the mapping device 100 comprises another embodiment of a display device 108. Unlike the detachable display device 54, the display device 108 is incorporated into the mapping device 100. The display device 108 shown in FIG. 8 is attached directly to the side of the satellite navigation receiver 22. The display device 108 may be configured to display both the location data screen 58 and the map screen 60 shown in FIG. 5. Alternatively, the display device 108 may be configured to just display data received from the locator 24 and the satellite navigation receiver 22. The display device 108 may include a touch screen interface and/or button controls. The mapping device 100 may be easier for an operator to handle due to its compact size as compared to the mapping device 18. However, the satellite navigation receiver 22 is known to be more accurate when situated at a great distance from the ground surface 14, as is the case with the mapping device 18.

In alternative embodiments, the satellite navigation receiver 22 shown in FIG. 8 may be configured so that the display device 54 may be releasably attached to the side of the receiver 22. For example, if the display device 54 is a smart phone, the receiver 22 may include a phone mount.

The various features and alternative details of construction of the apparatuses described herein for the practice of the present technology will readily occur to the skilled artisan in view of the foregoing discussion. It is to be understood that even though numerous characteristics and advantages of various embodiments of the present technology have been set forth in the foregoing description, together with details of the structure and function of various embodiments of the technology, this detailed description is illustrative only, and changes may be made in detail. Changes may be made in detail especially in matters of structure and arrangements of parts within the principles of the present technology to the full extent indicated by the broad general meaning of the terms in which the appended claims are expressed.

1. An apparatus, comprising:
an underground mapping device, comprising:
a survey pole having a first longitudinal axis;
a satellite navigation receiver supported on the survey pole;
a locator supported on the survey pole, the locator having a second longitudinal axis and comprising at least one antenna configured to detect an electromagnetic field;
in which the first longitudinal axis coincides with the second longitudinal axis.

2. A system comprising:
the apparatus of claim 1; and
a display device in communication with the satellite navigation receiver and the locator; in which the display device is configured to display locating data received from the locator and a map of points identified by the satellite navigation receiver.

3. The apparatus of claim 1, in which the satellite navigation receiver is a GNSS receiver.

4. The apparatus of claim 1, in which the survey pole comprises an elongate body and a spike; and in which the locator is interposed between the elongate body and the spike.

5. The apparatus of claim 1, in which the satellite navigation receiver has a third longitudinal axis; and in which the third longitudinal axis coincides with the first and second longitudinal axes.

6. The system of claim 2, in which the locating data and the map are displayed simultaneously on a split-screen on the display device.

7. The system of claim 2, in which the display device is supported on the survey pole.

8. The apparatus of claim 1, in which the survey pole comprises opposed upper and lower ends; and in which the satellite navigation receiver is positioned at the upper end and the locator is positioned at the lower end.

9. The apparatus of claim 1, in which the mapping device is at least two meters in height.

10. A method of using the system of claim 2, the method comprising:
measuring a location of the survey pole using the satellite navigation receiver;
simultaneously locating an underground utility using the locator at the location; and
thereafter, observing the location of the underground utility on the map on the display device.

11. The system of claim 2, in which the locator and the satellite navigation receiver each communicate with the display device using Bluetooth.

12. The system of claim 2, in which the display device is a handheld tablet.

13. The system of claim 2, in which the map is an aerial map of the surrounding environment with locations identified by the satellite navigation receiver identified thereon.

14. An apparatus, comprising:
an underground mapping device, comprising:
a survey pole having an elongate body, the elongate body having opposed upper and lower ends;
a satellite navigation receiver supported on the upper end of the survey pole; and
a locator supported on the lower end of the survey pole, the locator comprising at least one antenna configured to detect an electromagnetic field;
in which at least a portion of the locator is positioned within a footprint of the satellite navigation receiver.

15. A system comprising:
the apparatus of claim 14; and
a display device in communication with the satellite navigation receiver and the locator; in which the display device is configured to display locating data received from the locator and a map of points identified by the satellite navigation receiver.

16. The apparatus of claim 14, in which the satellite navigation receiver is a GNSS receiver.

17. The apparatus of claim 14, in which the survey pole comprises an elongate body and a spike; and in which the locator is interposed between the elongate body and the spike.

18. A method of using the system of claim 2, the method comprising:
measuring a location of the survey pole using the satellite navigation receiver; and
simultaneously locating an underground utility using the locator at the location.

19. The method of claim 18, further comprising the step of:
observing the location of the underground utility on the map on the display device.

20. The apparatus of claim 14, in which the mapping device is at least two meters in height.
